(19) United States
(12) Patent Application Publication
(10) Pub. No.: US 2023/0393900 A1
(43) Pub. Date: Dec. 7, 2023

(54) DATABASE SYSTEMS AND METHODS WITH ASYMMETRIC NODES

(71) Applicant: MongoDB, Inc., New York, NY (US)

(72) Inventors: Karen Lin, New York, NY (US); Harish Salem Chandramowli, New York, NY (US); Augustin Liebster, New York, NY (US); Robert Liles, New York, NY (US); Cory P. Mintz, Millstone Township, NJ (US); Mark Porter, Seattle, WA (US); Lori Berenberg, New York, NY (US); Christopher Shum, New York, NY (US)

(73) Assignee: MongoDB, Inc., New York, NY (US)

(21) Appl. No.: 18/328,953

(22) Filed: Jun. 5, 2023

Related U.S. Application Data
(60) Provisional application No. 63/349,362, filed on Jun. 6, 2022.
(60) Provisional application No. 63/349,392, filed on Jun. 6, 2022.

(51) Int. Cl. G06F 9/50; G06F 16/27

(52) U.S. Cl. CPC G06F 9/5044; G06F 9/5077; G06F 9/5072; G06F 16/27; G06F 2209/505; G06F 2209/501

(57) ABSTRACT

A database system may use asymmetric hardware for analytics nodes. In some embodiments, a database system includes a replica set comprising a plurality of base nodes and at least one analytics node. The analytics nodes may have asymmetric hardware respective to the base nodes. The base nodes may include a primary node and two secondary nodes. The primary node may be configured to accept writes and propagate the writes to secondary nodes and may also propagate writes to analytics nodes. Secondary nodes may replicate writes and accept reads. Analytics nodes may perform data analysis operations. Analytics nodes may have a first instance size different than a second instance size of the base nodes.

### RELATED APPLICATIONS

This application claims the benefit under 35 U.S.C. § 119(e) of U.S. Provisional Application Ser. No. 63/349,362, filed Jun. 6, 2022, under Attorney Docket No. T2034.70068US00, and entitled “DATABASE SYSTEMS AND METHODS WITH ASYMMETRIC NODES,” which is hereby incorporated herein by reference in its entirety. This Application claims the benefit under 35 U.S.C. § 119(e) of U.S. Provisional Application Ser. No. 63/349,392, filed Jun. 6, 2022, under Attorney Docket No. T2034.70072US00, and entitled “SYSTEMS AND METHOD FOR MANAGING A DISTRIBUTED DATABASE,” which is hereby incorporated herein by reference in its entirety.

### COPYRIGHT NOTICE

At least a portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Some conventional database systems may have a plurality of nodes with each node having symmetric hardware. For example, instance size of each node may be required to be the same.

### SUMMARY

According to aspects of the disclosure, there is provided a cloud database system for hosting data using asymmetric hardware for analytics nodes. The system comprises at least one cloud-based resource, the at least one cloud-based resource including a processor and a memory and a database subsystem executing on the at least one cloud-based resource. The database subsystem comprises a replica set configured to store data. The replica set includes a plurality of base nodes comprising a primary node and two secondary nodes. The primary node is configured to accept, from client systems, database write operations and responsive to accepting the database write operations, propagate the database write operations to secondary nodes. Each secondary node is configured to, responsive to receiving the database write operations from the primary node, replicate the database write operations and accept, from client systems, database read operations. The replica set is configured to aspect specification of at least one analytics node configured to perform data analysis operations, the at least one analytics node having asymmetric hardware respective to the base nodes of the plurality of base nodes.

In some embodiments, at least one analytics node has a first instance size and the base nodes of the plurality of base nodes have a second instance size different than the first instance size.

In some embodiments, the first instance size is larger than the second instance size.

In some embodiments, the first instance size is smaller than the second instance size.

In some embodiments, the database system is configured to receive input from a customer customizing the first instance size to be different than the second instance size.

In some embodiments, the input indicates at least one of: (a) a first cluster tier and a second cluster tier different than the first cluster tier; (b) a first class and a second class different than the first class; (c) first cluster-tier auto-scaling and second cluster-tier auto-scaling different than the first cluster-tier auto-scaling; or (d) a first IOPS and a second IOPS different than the first IOPS.

In some embodiments, the database system is further configured to receive additional input from the customer specifying a symmetric IOPS for the at least one analytics node and the base nodes of the plurality of base nodes.

According to aspects of the disclosure, there is provided a computer implemented method for hosting data using asymmetric hardware for analytics nodes, the method performed using a database subsystem executing on at least one cloud-based resource including a processor and a memory, the database subsystem comprising a replica set configured to store data, the replica set including a plurality of base nodes comprising a primary node and a secondary node, the method comprising: using the primary node, accepting, from client systems, database write operations and responsive to accepting the database write operations, propagating the database write operations to secondary nodes, using each of the two secondary nodes, responsive to receiving the database write operations from the primary node, replicating the database write operations and accepting, from client systems, database read operations, and using the replica set, accepting specification of at least one analytics node configured to perform data analysis operations, the at least one analytics node having asymmetric hardware respective to the base nodes of the plurality of base nodes.

According to aspects of the disclosure, there is provided at least one non-transitory computer-readable storage medium having instructions encoded thereon that, when executed by at least one processor, cause the at least one processor to perform a method for hosting data using asymmetric hardware for analytics nodes, the method performed using a database subsystem executing on at least one cloud-based resource including a processor and a memory, the database subsystem comprising a replica set configured to store data, the replica set including a plurality of base nodes comprising a primary node and a secondary node, the method comprising using the primary node, accepting, from client systems, database write operations and responsive to accepting the database write operations, propagating the database write operations to secondary nodes, using each of the two secondary nodes, responsive to receiving the database write operations from the primary node, replicating the database write operations and accepting, from client systems, database read operations, and using the replica set, accepting specification of at least one analytics node configured to perform data analysis operations, the at least one analytics node having asymmetric hardware respective to the base nodes of the plurality of base nodes.

Still other aspects, embodiments, and advantages of these exemplary aspects and embodiments, are discussed in detail below. Moreover, it is to be understood that both the foregoing information and the following detailed description are merely illustrative examples of various aspects and embodiments and are intended to provide an overview or framework for understanding the nature and character of the claimed aspects and embodiments. Any embodiment disclosed herein may be combined with any other embodiment in any manner consistent with at least one of the objectives, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. Various aspects, embodiments, and implementations discussed herein may include means for performing any of the recited features or functions.

### BRIEF DESCRIPTION OF DRAWINGS

Various aspects of at least one example are discussed below with reference to the accompanying figures, which are not intended to be drawn to scale. The figures are included to provide an illustration and a further understanding of the various aspects and examples and are incorporated in and constitute a part of this specification but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is block diagram of an example system, according to one embodiment;

FIG. 2 is an example block diagram of a special purpose computer system that can be configured to execute the functions discussed herein; and

FIGS. 3A-3C are example screen captures of user interfaces, according to some embodiments.

### DETAILED DESCRIPTION

A database system may use asymmetric hardware for analytics nodes. In some embodiments, a database system includes a replica set comprising a plurality of base nodes and at least one analytics node. The analytics nodes may have asymmetric hardware respective to the base nodes. The base nodes may include a primary node and two secondary nodes. Primary nodes may be configured to accept writes and propagate the writes to read-only nodes. Secondary nodes may replicate writes and accept reads. Analytics nodes may perform data analysis operations. Analytics nodes may have a first instance size different than a second instance size of the base nodes (for example, base nodes may include electable and read-only nodes).

In some embodiments, a database system may include one or more electable nodes. Electable nodes may be nodes that are configured to be eligible to be elected as a primary node. For example, electable nodes may comprise a current primary node and current secondary nodes. As discussed below, primary nodes may be configured to perform write operations.

The system may further include one or more non-electable nodes. Non-electable nodes may include analytics nodes or read-only nodes.

In some embodiments, a database system may include one or more analytics nodes. An analytics node may be a secondary node that is configured to be ineligible to be elected as primary node. In some embodiments, analytics nodes may be configured to perform read operations for analytics or may be configured to exclusively perform read operations for analytics. In some embodiments, analytics nodes may be configured to not perform operational queries or may be isolated from primary and secondary nodes so to not contend with operational workload. A system may isolate analytics nodes so that, if a number of queries to the analytics nodes is overwhelming, there is a reduced or eliminated risk primary and secondary nodes being taken down. In some embodiments, analytics nodes are configured for data analysis operations.

In some embodiments, a database system may include one or more read-only nodes. Read-only nodes may be configured to be ineligible to be elected as a primary node. In some embodiments, read-only nodes may be secondary nodes that are configured to only perform read operations. In some embodiments, read-only nodes may be configured to perform operational queries or analytics queries. Read-only nodes may be configured to be limited to performing read operations.

In some embodiments, a database system may include one or more base nodes. Base nodes may comprise at least one of read-only nodes or electable nodes, and may also include hidden secondary nodes.

In some embodiments, a database system may include asymmetric hardware. Such a system may comprise analytics nodes that have asymmetric hardware relative to other nodes of the system. For example, clusters of a database system may have analytics nodes having a first instance size different from a second instance size of electable and/or read-only nodes. In some embodiments, instance size of a node may comprise a tier-based designation of the node. Instance size may include the hardware of a node, for example, CPU, memory, storage, networking capacity, and/or other hardware parameters of the node.

In some embodiments, systems may provide customers with user interfaces (e.g., a graphical user interface (GUI)) configured to customize analytics nodes. For example, system may allow customers to specify, via such a user interface, an instance size and compute auto-scaling bounds for an analytics node that differs from instance size configuration of base nodes. The user interface may prompt the user to specify size. For example, the prompting may be performed during setup of a new user, or the prompting may be provided within a menu specifying settings for the user. In some embodiments, the user interface may further include an option for the user to opt out of asymmetric hardware.

According to aspects of the disclosure, an analytics node instance size may be higher than base node instance size. The higher size may be specified by the user in a user interface as described herein, or may be selected automatically by the system to scale with a user's usage. In some embodiments, analytics nodes with higher instance sizes provide benefits including decreased query time due to more hardware, quicker query repeats due to a larger cache, and improved complex aggregation time due to more available CPU usage.

According to aspects of the disclosure, an analytics node instance size may be smaller than base node instance size. The smaller size may be specified by the user in a user interface as described herein, or may be selected automatically by the system to scale with a user's usage. In some embodiments, the smaller instance size may allow customers to reduce costs, for example, when they have limited analytics usage. In some embodiments, customers may not know analytics needs when creating a cluster and may use instance size auto scaling on analytics nodes, reducing system complexity presented to the customers. Auto scaling of analytics nodes may be independent of electable and read-only node auto scaling.

Database systems described herein may serve complex and varied customer specifications, including various analytics use cases. Customers may have robust analytics needs, and aspects of the disclosure may allow customers to provision more hardware to serve their analytics nodes. In some embodiments, customers may have lesser analytics needs, and aspects of the disclosure may allow the customers to use a reduced or minimum hardware to may meet their requirements, thereby reducing cost.

In conventional database systems, all nodes in a cluster may generally be required to be the same tier, despite nodes having different uses. Using an analytics node allows customers to isolate queries so the queries do not compete with operational workload. Unlike the symmetric nodes required in conventional database systems, asymmetric hardware of analytics nodes provides customers control of the underlying storage and memory for analytics workloads. Systems described herein may allow users to scale up analytics node tier to provide faster queries as a result of more hardware. With increased memory, customers may more easily run repeat queries using a larger in-memory cache. More CPU allows more complex aggregations. Users may also scale their analytics node tiers down to benefit from cost reduction in situations where their analytics nodes might be underused or not require fresh data, which may reduce cost to the user.

Analytics nodes may have a different cluster tier than electable nodes. For example, the system may accept user specification of analytics nodes with either larger or smaller cluster tiers than electable nodes. The system may accept user edits to an existing analytics node to make it a different tier than their electable nodes. The system may accept user selection of a cluster tier from the defined options available for their analytics node (for example, M30, M40, etc.). When a cluster has multiple analytics nodes, all analytics nodes in a cluster may have the same tier or may be limited to having the same tier. In some embodiments, analytics nodes may be configured to auto scale cluster tier independently of autoscaling of electable nodes. For example, when an electable node scales up, analytics nodes may auto scale based on their own criteria. In some embodiments, the system may limit autoscaling to cluster tier. In some embodiments, the system may limit autoscaling of disk size of analytics nodes.

In various embodiments, some settings may be customized for analytics node tiers and settings that may be consistent with base tiers. Exemplary asymmetric settings where the system allows a customer to configure settings for their analytics tier may include cluster tier (e.g., M10, M20, etc.), class (e.g., General, Low CPU, Local NVMe SSD), IOPS, and/or Cluster Tier Auto-Scaling. Exemplary symmetric settings where the system may have an analytics tier inherit the settings from base tier include disk size, IOPS, and/or storage scaling.

A graphical user interface (GUI) or other user interface (UI) or documentation may prompt users with education throughout the UI or documentation that is configured to guide the users through a decision of selection of making an analytics node asymmetric. For example, the UI or documentation may display, to a user, problems that more hardware may solve for analytics use cases, as well as problems that may not be solved. The UI or documentation may display, to a user, guidelines for selecting an optimal tier for asymmetric nodes.

In some embodiments, the system may warn users of the potential impacts of selecting a cluster tier for their analytics node that is smaller than their electable nodes. The system may provide information to users to inform them of potential issues of replication lag. Generally, analytics nodes may provide more throughput. In some embodiments, customers may be limited from starting up analytics nodes that are a threshold amount smaller than the operational tier. Other embodiments may allow for lower tier analytics nodes. For example, a system may provide alerts that get triggered when an analytics node is perpetually behind the electable node due to having a smaller cluster tier. The system may allow users to configured replication lag by design.

The system may be configured to bill customer cluster use, based on a Cluster Description object or instance hardware. Multiple instance sizes may be billed for when asymmetric hardware is provided. Analytics node tiers may be priced similar to or the same as pricing of cluster tiers. For example, when an analytics node tier is higher or lower than the base tier, the system may adjust price on a prorated per-node basis. The separate pricing may be visible both in a cluster preview as well as a checkout workflow.

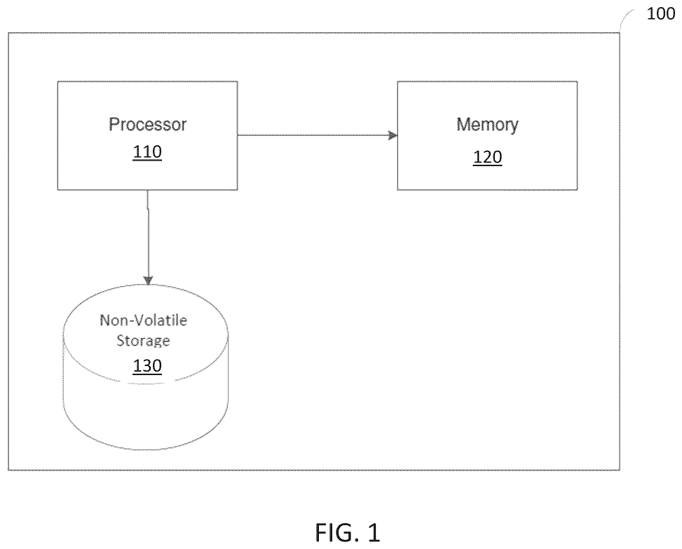

An illustrative implementation of a computer system 100 that may be used in connection with any of the embodiments of the disclosure provided herein is shown in FIG. 1. The computer system 100 may include one or more processors 110 and one or more articles of manufacture that comprise non-transitory computer-readable storage media (e.g., memory 120 and one or more non-volatile storage media 130). The processor 110 may control writing data to and reading data from the memory 120 and the non-volatile storage device 130 in any suitable manner. To perform any of the functionality described herein, the processor 110 may execute one or more processor-executable instructions stored in one or more non-transitory computer-readable storage media (e.g., the memory 120), which may serve as non-transitory computer-readable storage media storing processor-executable instructions for execution by the processor 110.

In one embodiment, a database system can be configured to permit read operations from any node in response to requests from clients. For reads, scalability becomes a function of adding nodes (e.g., servers) and database instances. Within the set of nodes, at least one node is configured as a primary server. A primary server/node provides the system with a writable copy of the database. In one implementation, only a primary node is configured to permit write operations to its database in response to client requests. The primary node processes write requests against its database and replicates the operation/transaction asynchronously throughout the system to connected secondary nodes.

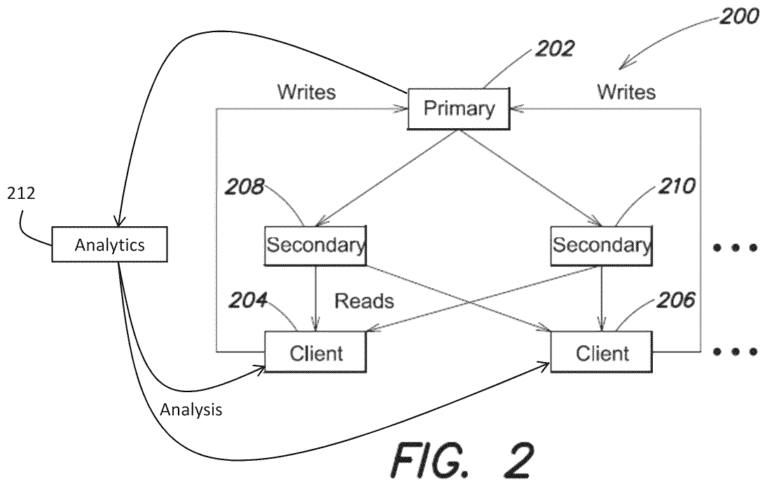

In another example, the group of nodes, primary and secondary nodes operate in conjunction to process and replicate database operations. This group of nodes can be thought of a logical unit, a replica set, for handling database operations. Shown, for example, in FIG. 2 are the basic elements of a replica set, a primary or master node 202, secondary nodes 208-210, and analytics node 212. The primary node's responsibility can transition between nodes 202, 208, and 210 within the replica set, permitting operation even in light of failures within the replica set. The secondary nodes 208-210 and analytics node 212 host replicas of the primary database. Secondary nodes 208-210 are configured to take on the primary role automatically in the event of a failure.

In another example, the primary node receives and performs client writes operations and generates an operation log. Each logged operation is replayed by the secondary nodes and analytics nodes bringing the replicated databases into synchronization. In some embodiments, the secondary nodes or analytics nodes query the primary node to identify operations that need to be replicated. The replica set and/or individual nodes can be configured to respond to read request from clients by directing read request to secondary nodes 208-210. The replica set and/or individual nodes can be configured to respond to data analysis operations from clients by directing data analysis operations to analytics node 212.

Clients, for example 204-206, from the perspective of a distributed database can include any entity requesting database services. A client can include an end-user system requesting database access and/or a connection to the database. An end-user system can request database services through an intermediary, for example an application protocol interface (API). The client can include the API and/or its associated drivers. Additionally, web-based services can interact with a distributed database, and the web-based services can be a client for the distributed database.

According to aspects of the disclosure, there is provided asymmetric hardware for analytics nodes. Provided is exemplary functionality and surface area for asymmetrical hardware for analytics nodes. Functionality of components is described and exemplary specific or pseudo code and implementation details are given.

In some embodiments, the system allows users to create a cluster where the users specify a different (for example, higher or lower) tier for one or more analytics node. Aspects of the disclosure may allow lower tier analytics nodes for customers who understand there may be issues with the node keeping up, but would benefit from the cost savings. For example, this may be an analytics team that doesn't need operations to complete very quickly and for their analysis purposes may scale down their analytics node. For example, a European analytics team goes on vacation for all of August and doesn't use their Analytics node much at all, among other examples.

According to some embodiments, users of the system may include established users who understand when adding hardware may facilitate their analytics workloads. In other embodiments for example, users may have a usage stage having a different familiarity with MongoDB, such as potential users, new users, expert users, etc. In various embodiments, the customer profile of the types of customers who may adopt aspects of the system may include users having varying analytics use cases.

Various conventional systems may not provide functionality to users to vary analytics hardware. For example, in some conventional systems, users would previously accomplish an increase in analytics usage (e.g., if the users needed more CPU, RAM, or IOPS for an analytics use case) and they would increase the tier for the entire replica set, which can be an inefficient use of resources for some users. Thus, conventional systems have negative consequences because users would unnecessarily over-provision just for the sake of analytics queries.

Systems described herein provide improved implementations over conventional systems. Users may now accomplish more efficient hardware use as the system provides the user the ability to choose an appropriately sized tier for their analytics node workload. For example, new and prospective customers with complex analytics needs may be able to handle more of their analytics workloads using Atlas or other implementations, creating more opportunities for both new business and retention. Aspects of the disclosure position MongoDB Atlas or other implementations as a premier cloud data platform for analytics, ensuring customers can handle all their data needs in one place.

Aspects of the disclosure provide a system with asymmetrically scaled analytics nodes. As Atlas and other implementations continue to scale and serve more complex and varied customer needs, analytics use cases rise further to the forefront. Serving those analytics use cases may allow the system to expand a potential customer base and grow the system's capabilities in serving all data needs. For those customers with robust analytics needs, aspects of the disclosure may provide them with the ability to provision more hardware specifically to their analytics nodes. For customers with lesser analytics needs, aspects of the disclosure may ensure they can only use a reduced or minimum hardware that may meet their requirements.

In some conventional systems, all nodes in a cluster may be the same tier, despite some having different uses. Using an analytics node allows customers to isolate their queries so they don't compete with the operational workload. For example, along with the MongoDB BI Connector, analytics nodes have been the foundation of analytics.

With the use of asymmetric hardware, aspects of the disclosure provide additional functionality to users, allowing users to better control the underlying storage and memory for their analytics workloads. The system provides users with the functionality to scale up their analytics node tier to benefit from faster queries as a result of more hardware. With increased memory, they can more easily run repeat queries using a larger in-memory cache. More CPU lends itself to more complex aggregations. The system also provides users with the functionality to scale their analytics node tiers down to benefit from cost reduction in situations where their analytics nodes might be underused or not require fresh data.

In some embodiments, asymmetric hardware may not aim to solve every analytics problem. For more complex aggregations, simply adding additional hardware may not ease the operational burden. However, aspects of the disclosure provide continued growth in features and settings specific to analytics nodes. In some embodiments, asymmetric hardware may be one of multiple steps to address the different needs between transactional and analytics use cases, and may be one aspect of analytics.

In some embodiments, analytics nodes can have different cluster tiers than electable nodes on M10+ clusters, for example. Users can create analytics nodes with either larger or smaller cluster tiers than electable nodes. Users may edit an existing analytics node to make it a different tier than their electable nodes. In some embodiments, users can choose a cluster tier from the defined options available for their analytics node (M30, M40, etc). When a cluster has multiple analytics nodes, all analytics nodes in a cluster may share the same tier, in other embodiments, the nodes in the cluster may be of a different tier. In some embodiments, analytics nodes can autoscale cluster tier independently of electable nodes. For example, if an electable node scales up, the analytics nodes may auto scale based on their own criteria.

In some embodiments, a graphical user interface (GUI) or other user interface may prompt users with education throughout the user interface to guide users through a decision of making an analytics node asymmetric. For example, the user interface may prompt the user with what problems more hardware can solve for analytics use cases, as well as problems that may not be solved. The user interface may provide the user with guidelines for how to select the right tier for their asymmetric nodes.

In some embodiments, the system may have customer changes relative to conventional systems. In some embodiments, there may not be a change to the default way something works, for example, because users may have to opt into the asymmetric nodes. In some embodiments, the asymmetric nodes may not deprecate existing functionality. In some embodiments, the behavior for new customers may be the same as the behavior for existing customers to simplify the system.

Aspects of the disclosure relate to product design. In some embodiments, systems described herein provide another option to cluster creation workflows, minimize visual clutter for users and avoid overwhelming users who do not have a use for features described herein. In some embodiments, the system may present creating asymmetric hardware as an option for users who are looking to create analytics nodes. In some embodiments, various elements in GUIs may be revised. For example, as one aspect of growing analytics, a title of the “Multi-Cloud, Multi-Region & Workload Isolation” toggle may be revised to reflect updated functionality. In some embodiments, Workload Isolation may not immediately jump out as the option to create an Analytics node and it may be named to guide users there. Because the “Multi-Cloud, Multi-Region & Workload Isolation” toggle is in the Cloud Provider & Region section, it comes before the Cluster Tier section. When the ability to select an analytics node tier is provided there, user may pick their analytics node tier before their electable node tier.

In some embodiments, the system may prompt the user with information related to revised billing associated with asymmetric nodes. Because auto-scaling a higher tier analytics node may lead to an unexpected bill, the system may link to documentation related to for Cluster Tier Scaling, which may be implemented in the Cluster tier section of the cluster builder. Upon analytics node setup, a system may default to two analytics nodes and may provide text that explains how two or more analytics nodes may benefit their cluster's high availability. The system may further warn users of the potential impacts of selecting a cluster tier for an analytics node that is smaller than electable nodes to ensure that users understand potential issues around replication lag. Generally, analytics nodes may provide more throughput. In some embodiments, customers may be limited from starting up analytics nodes that are smaller than the operational tier. Other embodiments may allow for lower tier analytics nodes.

Aspects of the disclosure relate to system engineering. In some embodiments, the system may provide alerts that are triggered when an analytics node is perpetually behind electable nodes due to having a smaller cluster tier. When a customer has configured this by design and is okay with replication lag, the system may allow a user to impact ongoing alerts, for example, by filtering or turning off certain alerts.

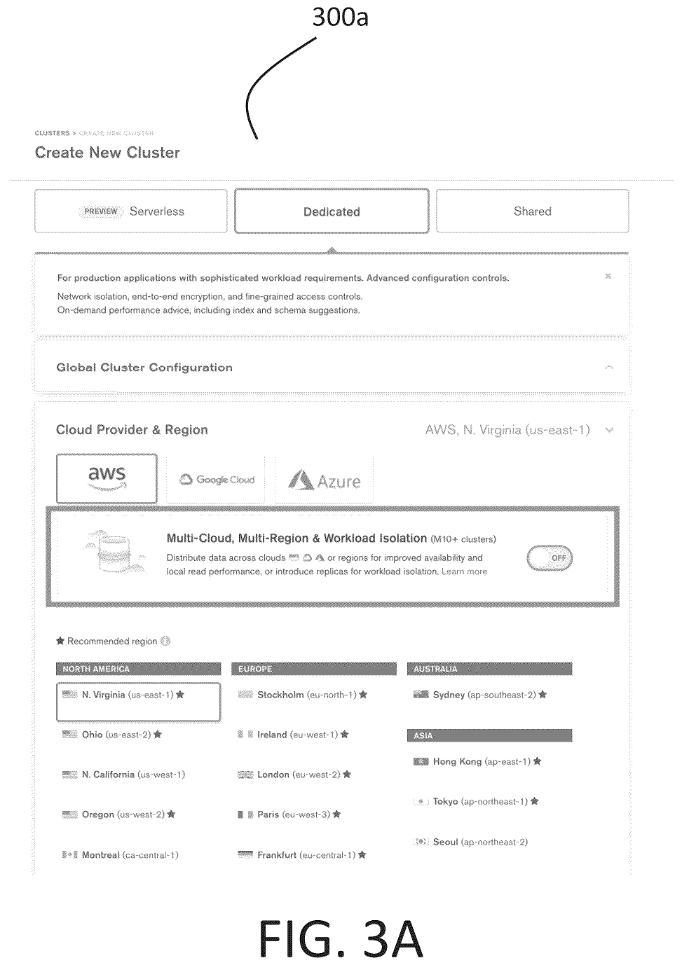

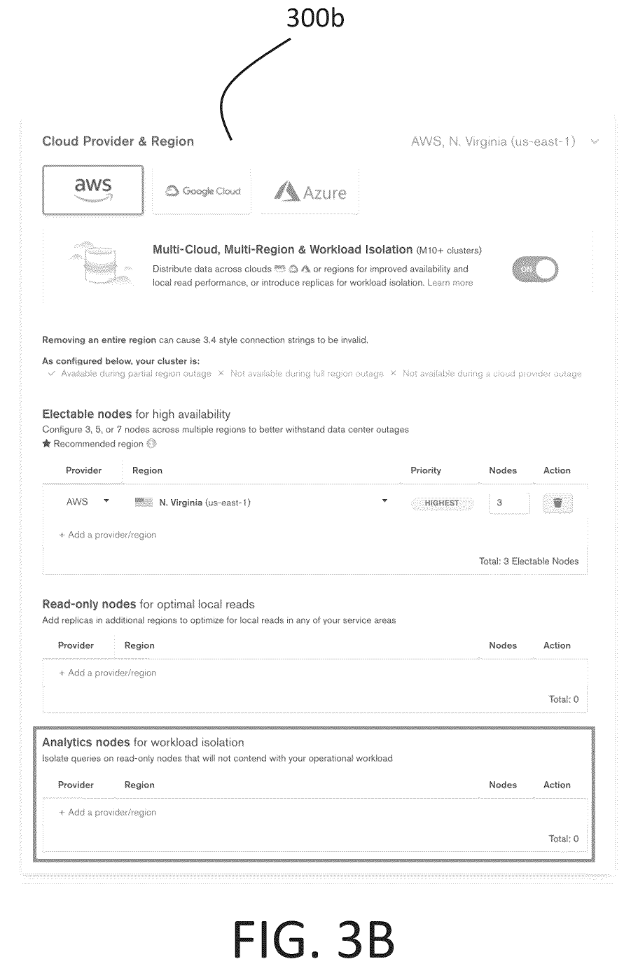

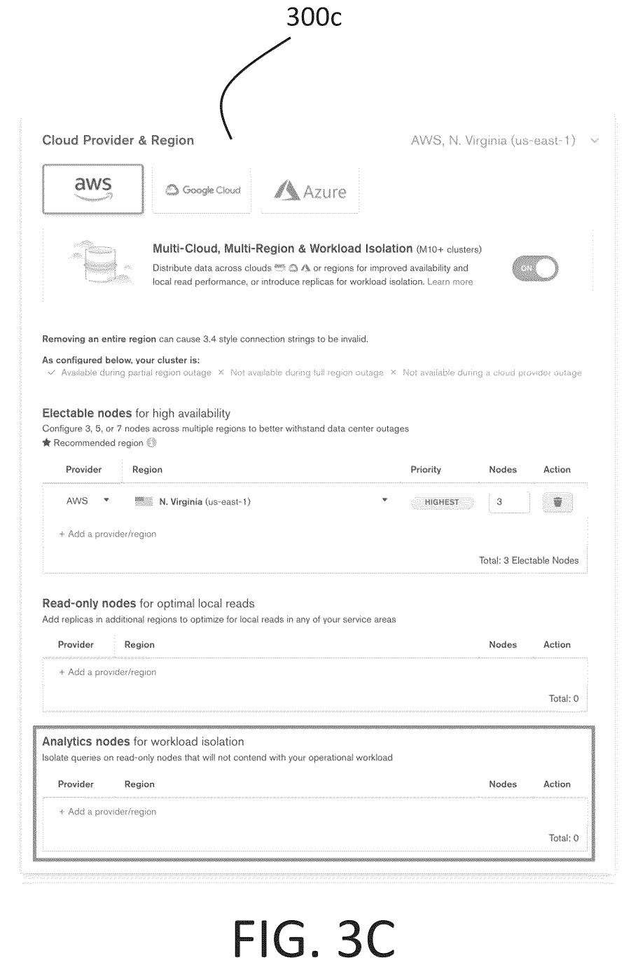

FIGS. 3A-3C are example screen captures of user interfaces (which may be graphical user interfaces (GUIs), according to some embodiments. FIG. 3A shows a cluster builder workload isolation user interface 300a. FIG. 3B shows a cluster builder workload isolation user interface 300b for creating analytics nodes. FIG. 3C shows a cluster builder tier selection user interface 300c.

According to aspects of the disclosure, scope of asymmetric nodes is described. In some embodiments, all replica set nodes on a cluster may be the same instance size. As Atlas and other systems grow and as use cases diversify, customers may want to customize their MongoDB or other analytics nodes. Customization of analytics nodes may be provided by the system by providing functionality allowing users to specify an instance size and compute auto-scaling bounds for their analytics nodes that differs from the instance size configuration of their base deployment nodes.

In some embodiments, analytics nodes with higher instance sizes may provide benefits like decreased query time due to more hardware, quicker query repeats due to a larger cache, and improved complex aggregation time due to more available CPU usage. Improvements due to increasing the instance size of analytics nodes may have diminishing returns on performance for some analytics workloads. In other embodiments, users who wish to save money or have only limited analytics needs may decrease the analytics node instance size. Users who do not know their analytics needs when creating a cluster may benefit from instance size auto scaling on analytics nodes. This auto scaling may be independent of electable and read-only node auto scaling.

A system may include various nodes. In some embodiments, electable nodes may be nodes that are eligible to be elected primary and perform write operations. In some embodiments, analytics nodes may be secondary nodes that cannot be elected primary and may be used for read operations for analytics. These nodes may not perform operational queries so to not contend with the workload. These nodes may be meant for data analysis operations. In some embodiments, read-only nodes may be secondary nodes that may only perform read operations and that may not be elected primary. These nodes perform operational queries and may be limited to read operations. In some embodiments, base nodes may be read-only nodes and electable nodes.

In some embodiments, nodes may have asymmetric hardware with different instance sizes. Asymmetric hardware may be clusters that have analytics nodes with an instance size different from the instance size of electable and read only nodes. Instance size may be a tier-based designation that refers to the hardware of a node, encompassing CPU, memory, storage, and networking capacity.

According to some embodiments, the system provides users with selectable options for cluster tiers for analytics nodes that are different from the tiers for electable and read-only nodes, via an API and the UI for clusters such as M10+ clusters. The system may include support to update analytics nodes instance size without updating the electable and read-only nodes instance size and vice versa. In some embodiments, a payload of API calls is provided for creating and updating clusters to optionally include specifications for asymmetrical hardware. If the payload does not include a second and different instance size for analytics nodes, the system may assign all nodes the provided instance size. In some embodiments, the system may provide instance size automatic scaling of analytics nodes in a manner independent of the automatic scaling of electable and read-only nodes. In some embodiments, if electable and read-only nodes update their instance size due to disk size automatic scaling, the system may assign the new instance size to the analytic nodes if the current analytics instance size cannot support the newly automatically scaled disk size. As such, in some embodiments, the system may violate fully independent instance size automatic scaling. Fully independent instance size may be violated in some cases because disk size automatic scaling can sometimes use an update in instance size to support the new disk size and disk size may be constant among all node types. Examples are provided herein.

According to aspects of the disclosure, instance size of a cluster may be used to determine the denominator for certain capacity based metrics. Metrics may be determined separately for analytics nodes and electable and read-only nodes as these node types may support different instance sizes. When selecting analytics instance size the base disk size may support that instance size. When enabling auto-scaling, the system may allow minimum and maximum instance sizes that are supported by the base disk size.

Aspects of the disclosure related to billing associated with asymmetric nodes. In some embodiments, the system may perform usage tracking logic to bill clusters with consideration of asymmetric hardware. The system may include logic that may estimate costs in the cluster builder user interface with consideration of asymmetric hardware. Activity feed events may reflect whether instance size auto-scaling was applied to analytics nodes, electable and read-only nodes, or both. In some embodiments, customers may be assisted in choosing the instance size of analytics nodes with educational prompts throughout the user interface. In some embodiments, the system may assume that all nodes have the same instance size when billing. Such a class may be aware of different instance sizes on analytics nodes and electable and read-only nodes. Estimates may reflect different instance size billing in the user interface when a customer creates the nodes.

Some embodiments relate to the system tracking usage of asymmetric nodes. For example, the system may perform segment tracking to track the number of clusters with analytics nodes, the number of clusters with analytics node tiers lower than base nodes tiers, and the number of clusters with analytics node tiers higher than base tiers.

The system may provide users with indications of expected performance based on their asymmetric node selections. Because a user may have a lower instance size for analytics nodes than electable and read-only nodes, the lower instance size may have replication lag. The system may prompt customers with performance information so that the customers may be responsible for understanding the consequences of a lower instance size for analytics nodes. For example, the system may have a cluster description class may pose a risk due to the high usage.

An auto scaling context document may be aware of auto scaling for analytics nodes and electable and read-only nodes separately. This is a path for auto scaling. Billing methods for Atlas or other clusters may be aware of asymmetric hardware. This may change a path in billing, described below. In some embodiments for example, Performance Advisor may suggest indexes for a replica set based off of a large number of slow queries on an asymmetric node due to it being under provisioned. Auto-indexing may include functionality to specifically check for resource consumption on all nodes before building an index. The instance size of a cluster is used to determine metrics which are then used for instance size auto-scaling. May determine CPU metrics separately for analytics nodes and electable/read-only nodes as these two node types may support different instance sizes. Users creating percentage based alerts may lead to confusion if the alerts are applied uniformly on all node types. As analytics nodes can have a different instance size and this instance size is used to calculate the percentages that trigger alerts, users may not be aware of the different thresholds needed to trigger an alert.

Further aspects of the disclosure relate to billing. For example, when billing for cluster use, the system may bill based on the Cluster Description object or the instance hardware. The system may have multiple instance sizes, and multiple instance sizes are billed correctly. In some embodiments, the system may bill without any consideration of node type, or may bill with consideration to node type.

In some embodiments, when instance size for analytics nodes and electable and read-only nodes are the same, the system may have a current instance size auto-scaling path that applies to both types of nodes. The system may decouple instance size auto-scaling for analytics nodes and electable and read-only nodes. The system may decouple instance size auto-scaling analytics nodes from instance size auto-scaling electable and read-only nodes.

Some embodiments relate to automatic scaling. When performing disk size automatic scaling for electable and read-only nodes, a side effect may be is scaling instance size. When instance size is changed for electable or read-only nodes due to disk size scaling, this may also scale analytics instance size. When the instance size of electable and read-only nodes is changed due to disk size automatic scaling, the system may update the instance size of the analytics nodes to be the same as the scaled instance size on the electable and read-only nodes. Since the disk size will be the same for all nodes, instance size auto-scaling resulting from disk size auto-scaling may be uniformly applied.

For a pre-existing analytics node that has a previously customized IOPS value, according to aspects of the disclosure, the system may not allow users to customize any hardware values other than instance size. For example, the system may choose the default value for IOPS provided in the instance size. When this feature is used and analytics nodes with customized IOPS value are encountered. First, the system may migrate the IOPS on an analytics node from customized to the default value for the analytics node's instance size, which may keep the customized IOPS value. Second, when a user selects a new instance size for their analytics nodes, the system may keep their previously customized IOPS value or may set the IOPS value to the default for the chosen instance size. Third, when scaling down the instance size for an analytics node, the system may block scaling down if the new instance size cannot support the previously customized IOPS value. When scaling up and the default IOPS value for the new instance size is larger than the previously customized IOPS value, the system may keep the customized IOPS or set the new, larger IOPS value. In various embodiments, IOPS may be a function of storage size. Since embodiments may keep storage size the same for analytics and electable and read-only nodes, the system may keep the IOPS value the same for analytics and electable and read-only nodes. For analytics nodes, in some embodiments, the system may assign the default IOPS value of the node's instance size. The system may keep the IOPS value uniform across analytic, electable, and read-only nodes regardless of instance size.

In some embodiments, there is provided cluster builder design and full page payment design for asymmetric hardware. In some embodiments, there is provided InTel work for automatic indexing that is conscious of node types when checking node resource consumption to build auto-indexes. In some embodiments, user interfaces may have analytics nodes with different instance sizes than electable and read-only nodes. In some embodiments, an API may be provided having analytics nodes with different instance sizes than electable and read-only nodes. In some embodiments, billing may be sensitive to different instance sizes on different node types. In some embodiments, automatic scaling may have scaling decoupled for analytics and electable and read-only nodes.

According to various aspects, there is provided a method that bills Atlas or other system clusters to make node type aware. In some embodiments, there is provided instance size documentation and documentation for electable, read-only, and analytics nodes.

In some embodiments, the system may validate that each cluster tier may be the same class. For example, the system may not allow an analytics tier on the R40 tier while the electable/read-only nodes are on M40. In some embodiments, a replica set metrics view may be aware of different node types. A replica set metric view may shows a single chart for each node in the replica set side by side where the x-axis is time and the y-axis is the metric. Since the scale of the y-axes is aligned, it may be possible for the values on a lower-provisioned node to be overshadowed by those on the higher-provisioned node.

Exemplary instance size scaling caused by disk size scaling is described. For example, base tier is M30, analytics tier is M40, disk size starts at 400 GB (which may be within range for both M30 and M40). When disk size grows to 700 GB (which may be out of range for M30, but within range for M40), the base tier scales up to M40, and the analytics tier stays at M40

According to various embodiments for example, Atlas analytics tiers, and other analytics tiers provide enhanced performance of customer analytics workloads by allowing customers to choose appropriately sized node tiers dedicated for analytics. For example, a customer may choose an analytics node tier that is larger or smaller than the operational nodes in a cluster. This added level of customization allows customers to get the performance desired for the customer's transactional and analytical queries without substantially over or under provisioning an entire cluster for the sake of an analytical workload.

In some embodiments, a base tier may be the cluster tier for the primary, secondary and read-only nodes in a cluster. The base tier may apply to nodes that are not the analytics node. Base nodes may also be operational nodes.

Various customers may user differing analytics node tiers. Two exemplary use cases for analytics node tiers are provided: making a customer's analytics tier higher than the base tier or lower than the base tier. These two use cases represent two different types of analytics customers. For example, customers might want to increase their analytics node tier because they have a large user base for their BI dashboards. Some customers may know they may use a large memory footprint to service their analytics needs. They may not want to pay the cost of scaling up their entire cluster tier. Alternatively, some customers might want to decrease their analytics node tier to reduce costs for their inconsistent or low priority analytics needs. These customers may not mind that their analytics node may experience replication lag, or lag may be a lower priority to these customers than other functionalities. These customers may be looking to reduce costs, for example, because they are seeing that their analytics tools have low users, or because they are shutting down for a time period, such as a summer vacation.

Aspects of the disclosure relate to presentation of analytics node tiers to users, and to transactional and analytic workloads. In some embodiments, appropriate products may be presented to customers at the right time. Analytics node tiers provide benefits for both uses within an application as well as for a business intelligence tool. For example, a customer who is building out an app with real time alerting might want to make their analytics node a higher tier to support greater usage than their operational nodes. Conversely, a team with a dashboard that gets used infrequently and who may not need to have faster response times might consider a lower analytics tier as a way to cut costs.

Exemplary settings that can be customized for analytics node tiers and settings that may be consistent with base tiers are provided. In some embodiments, there are exemplary asymmetric settings. For example, in some embodiments, customers can configure settings for their analytics tier including: cluster tier (e.g., M10, M20, etc.), class (e.g., general, low CPU, local NVMe SSD), and cluster tier automatic scaling. Exemplary settings that may be symmetric are provided. For example, in some embodiments, an analytics tier may inherit the following settings from base tier: disk size, IOPS, and storage scaling.

According to aspects of the disclosure, features of analytics node tiers are provided. Analytics node tiers may have the same settings as the base tier. Some settings may differ, described below. Disk size (e.g., storage) may be the same across both the base tier and analytics tier. When storage is the same, storage can be edited on the base tier, and may not be edited on the analytics tier. This may apply to enabling storage auto-scaling as well. When storage may not editable and may be the same between both base and analytics tier, IOPS may also be the same. When either the base tier or the analytics tier is Local NVMe SSD and the other is General/Low-CPU, both tiers may still have the same disk size. As a result, the node tier that is NVMe may define the disk size. When both the base tier and the analytics tier are Local NVMe SSD, they may be the same cluster tier because they share the same disk size (since NVMe has a specific disk size per cluster tier). When disk size may be the same between base and analytics tier, the analytics tier may not be one which does not support the disk size configured on the base (e.g., if the base tier is M60 with 1 TB disk size, the analytics tier may not be M10).

Challenges associated with analytics node tiers are described. A risk of using analytics node tier is setting an analytics tier 2+ tiers below the base tier. These clusters may experience replication lag from the primary. This may mean that analytics data may be hours behind the primary. This may be a non-issue for some clients and if a client understands the risk, they may choose to set up their cluster this way. Additionally, customers may configure auto-scaling on their base tier but not their analytics tier, and vice versa. If customers configure their cluster this way, there may be a risk of creating a large gap between their analytics and base tier which may lead to replication lag.

Aspects of the disclosure may be provided for particular analytics node tiers and cluster types. For example, analytics node tiers may be available on M10+ clusters. They may not be available on shared or serverless instances. In some embodiments, particular MongoDB versions may be supported by analytics node tiers. For example, MongoDB versions 4.2+ may be supported.

Further aspects relate to pricing for analytics node tiers. For example, analytics node tiers may be priced similar to previous pricing of cluster tiers. When an analytics node tier is higher or lower than the base tier, the price may adjust accordingly on a prorated per-node basis. The separate pricing may be visible both in the cluster preview as well as the checkout workflow.

Cluster tier settings and changes for clusters without analytics nodes enabled. For example, users may see an updated cluster tier section when their cluster uses analytics nodes. In some embodiments, existing clusters may opt-in to use analytics node tiers. For example, existing clusters can add analytic nodes with and without using a different analytics tier.

Additional aspects of analytics node tiers are described. Analytics node tiers is one of multiple features that may allow customers to customize their cluster set up specifically to accommodate their analytics use cases. In addition to analytics node tiers, there may be analytics indexes which may allow analytics nodes to have unique indexes from their operational nodes. These two features combined enable cluster configurations that honor the distinct workloads analytics nodes see.

In conventional systems, users may apply one instance size to all of their node types. For customers who have robust analytics implementations, aspects of the disclosure therefore provide them with the ability to provision analytics nodes with a higher instance size than the base nodes. Aspects may also provide analytics nodes to be able to auto-scale instance size (rather than disk size) independently of base nodes. As discussed above, systems described herein may have enhanced design components, related to cluster creation, automatic scaling, and billing.

The system may provide various metrics regarding asymmetric nodes. One metric may include service health. A service health metric may track service health by using verbose logging in three main paths. One may be the path of creating or updating a cluster that includes analytics nodes with different instance sizes. A second may be the path where independent instance-size scaling happens for analytics nodes. A third may be the path where analytics nodes instance sizes are updated due to disk size auto-scaling of the base nodes. Auto scaling may be tracked. There may be segment events tracked for analytics nodes.

Another metric may include feature usage tracking. For example, the system may track three events: first, that a cluster was created containing analytics nodes, second, that a cluster was updated to contain analytics nodes, and third, that a cluster has analytics nodes with an instance size greater or less than the instance size of the base node.

In some embodiments, an analytics node may scale instance size in response to base node disk size automatic scaling. Thus, it is possible the analytics nodes update due to the base nodes, which could lead to customer confusion. In various embodiments, the system may prompt the user with information related to analytics node updates to avoid such confusion.

It should be appreciated that various examples above each describe functions that can be and have been incorporated in different system embodiments together. The examples and described functions are not exclusive and can be used together. Modifications and variations of the discussed embodiments will be apparent to those of ordinary skill in the art and all such modifications and variations are included within the scope of the appended claims.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples (e.g., the processes described with reference to figures and functions above, the various system components, analysis algorithms, processing algorithms, etc.) have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

1. A cloud database system for hosting data using asymmetric hardware for analytics nodes, the system comprising:
at least one cloud-based resource, the at least one cloud-based resource including a processor and a memory;
a database subsystem executing on the at least one cloud-based resource, wherein the database subsystem comprises:
a replica set configured to store data, the replica set including a plurality of base nodes comprising:
a primary node configured to:
accept, from client systems, database write operations; and
responsive to accepting the database write operations, propagate the database write operations to secondary nodes;
two secondary nodes each configured to:
responsive to receiving the database write operations from the primary node, replicate the database write operations; and
accept, from client systems, database read operations;
wherein the replica set is configured to accept specification of at least one analytics node configured to perform data analysis operations, the at least one analytics node having asymmetric hardware respective to the base nodes of the plurality of base nodes.

2. The database system of claim 1, wherein at least one analytics node has a first instance size and the base nodes of the plurality of base nodes have a second instance size different than the first instance size.

3. The database system of claim 2 wherein the first instance size is larger than the second instance size.

4. The database system of claim 2 wherein the first instance size is smaller than the second instance size.

5. The database system of claim 2, wherein the database system is configured to receive input from a customer customizing the first instance size to be different than the second instance size.

6. The database system of claim 5, wherein the input indicates at least one of:
(a) a first cluster tier and a second cluster tier different than the first cluster tier;
(b) a first class and a second class different than the first class;
(c) first cluster-tier auto-scaling and second cluster-tier auto-scaling different than the first cluster-tier auto-scaling; or
(d) a first IOPS and a second IOPS different than the first IOPS.

7. The database system of claim 6, wherein the database system is further configured to receive additional input from the customer specifying a symmetric IOPS for the at least one analytics node and the base nodes of the plurality of base nodes.

8. A computer implemented method for hosting data using asymmetric hardware for analytics nodes, the method performed using a database subsystem executing on at least one cloud-based resource including a processor and a memory, the database subsystem comprising a replica set configured to store data, the replica set including a plurality of base nodes comprising a primary node and a secondary node, the method comprising:
using the primary node:
accepting, from client systems, database write operations; and
responsive to accepting the database write operations, propagating the database write operations to secondary nodes;
using each of the two secondary nodes:
responsive to receiving the database write operations from the primary node, replicating the database write operations; and
accepting, from client systems, database read operations; and
using the replica set, accepting specification of at least one analytics node configured to perform data analysis operations, the at least one analytics node having asymmetric hardware respective to the base nodes of the plurality of base nodes.

9. The method of claim 8, wherein at least one analytics node has a first instance size and the base nodes of the plurality of base nodes have a second instance size different than the first instance size.

10. The method of claim 9 wherein the first instance size is larger than the second instance size.

11. The method of claim 9 wherein the first instance size is smaller than the second instance size.

12. The method of claim 9, further comprising receiving input from a customer customizing the first instance size to be different than the second instance size.

13. The method of claim 12, wherein the input indicates at least one of:
(a) a first cluster tier and a second cluster tier different than the first cluster tier;
(b) a first class and a second class different than the first class;
(c) first cluster-tier auto-scaling and second cluster-tier auto-scaling different than the first cluster-tier auto-scaling; or
(d) a first IOPS and a second IOPS different than the first IOPS.

14. The method of claim 13, further comprising receiving additional input from the customer specifying a symmetric IOPS for the at least one analytics node and the base nodes of the plurality of base nodes.

15. At least one non-transitory computer-readable storage medium having instructions encoded thereon that, when executed by at least one processor, cause the at least one processor to perform a method for hosting data using asymmetric hardware for analytics nodes, the method performed using a database subsystem executing on at least one cloud-based resource including a processor and a memory, the database subsystem comprising a replica set configured to store data, the replica set including a plurality of base nodes comprising a primary node and a secondary node, the method comprising:
using the primary node:
accepting, from client systems, database write operations; and
responsive to accepting the database write operations, propagating the database write operations to secondary nodes;
using each of the two secondary nodes:
responsive to receiving the database write operations from the primary node, replicating the database write operations; and
accepting, from client systems, database read operations; and
using the replica set, accepting specification of at least one analytics node configured to perform data analysis operations, the at least one analytics node having asymmetric hardware respective to the base nodes of the plurality of base nodes.

16. The at least one non-transitory computer-readable storage medium of claim 15, wherein:
at least one analytics node has a first instance size and the base nodes of the plurality of base nodes have a second instance size different than the first instance size; and
the first instance size is larger than the second instance size.

17. The at least one non-transitory computer-readable storage medium of claim 15, wherein:
at least one analytics node has a first instance size and the base nodes of the plurality of base nodes have a second instance size different than the first instance size; and
the first instance size is smaller than the second instance size.

18. The at least one non-transitory computer-readable storage medium of claim 15, wherein:
at least one analytics node has a first instance size and the base nodes of the plurality of base nodes have a second instance size different than the first instance size; and
the method further comprises receiving input from a customer customizing the first instance size to be different than the second instance size.

19. The at least one non-transitory computer-readable storage medium of claim 18, wherein the input indicates at least one of:
(a) a first cluster tier and a second cluster tier different than the first cluster tier;
(b) a first class and a second class different than the first class;
(c) first cluster-tier auto-scaling and second cluster-tier auto-scaling different than the first cluster-tier auto-scaling; or
(d) a first IOPS and a second IOPS different than the first IOPS.

20. The at least one non-transitory computer-readable storage medium of claim 19, wherein the method further comprises receiving additional input from the customer specifying a symmetric IOPS for the least at one analytics node and the base nodes of the plurality of base nodes.
